(19) United States
(12) Patent Application Publication
(10) Pub. No.: US 2008/0248150 A1
(43) Pub. Date: Oct. 9, 2008

(54) Mold-Carrier Unit For Thermoformable Container Blow-Molding Machine

(76) Inventors: Denis Gillet, Octeville sur Mer (FR); Alexandre Toutoux, Octeville sur Mer (FR); Pierre-Francois Langlois, Octeville sur Mer (FR); Arnaud Barbey, Octeville sur Mer (FR)

Correspondence Address: YOUNG & THOMPSON, 209 Madison Street, Suite 500, ALEXANDRIA, VA, 22314, US

(21) Appl. No.: 12/064,834

(22) PCT Filed: Aug. 22, 2006
(86) PCT No.: PCT/EP06/65560

§ 371 Date: Feb. 26, 2008

(30) Foreign Application Priority Data
Aug. 29, 2005 (FR) 05/52592

(51) Int. Cl. B29C 49/48; B29C 49/56

(52) U.S. Cl. 425/188; 425/182

(57) ABSTRACT

The invention concerns a mold-carrier unit for a thermoplastic container blowing machine. The mold-carrier unit is designed to equip a machine for making containers obtained by blow-molding, and optionally by elongation, based on a thermoplastic preform. The unit comprises at least one rotatable mobile panel (3, 5), bearing articulating lugs on a first edge and bearing locking lugs (17, 15) on a second edge, the mobile panel including at least one rib (31, 33, 39; 41, 45, 49) enabling at least one locking lug to be connected with at least one articulating lug such that the rib reinforces the rigidity of the mold-carrier unit.

The present invention relates to a mold-carrier unit for a thermoformable container blow-molding machine.

The prior art includes a description of the structure and principal components of a blow-molding machine for thermoplastic containers. A container of this type is initially produced as a preform which includes the quantity of material required for forming by molding, blowing and/or stretching inside a mold having an initial shape which, on completion of the blowing and/or stretching operations, will affect the final shape of the desired container such as a bottle.

In a conventional example of embodiment, the preform consists of a hollow tube of substantially cylindrical shape, which is closed at one end which will form the base of the container in its final shape, and open at the other end which will form the neck of the container in its final shape.

The preform is inserted into the container blow-molding machine and is presented in a first orientation, for example with the neck uppermost, at the entrance of a heating furnace which raises the temperature of the preform to make it malleable before the blowing and/or stretching operations and the molding operation, so that the finished container can be given the desired shape. For this purpose, the preform, which is heated on leaving the furnace, is conveyed rapidly, to prevent resolidification, toward a set of molds mounted on a rotating plate. Each mold associated with the rotating plate of the set of molds concerned is composed of a mold-carrier unit and a mold proper, whose upper part is initially opened for the insertion of the heated preform, with a cover for creating a closed space inside the mold into which the heated preform has been inserted.

Since the preforms are inserted into the blow-molding machine at the highest possible rate, the period for which the mold is inactive must be reduced to an absolute minimum. Since the mold is mounted on a rotating plate, and since the plate rotates as rapidly as possible, in order to reduce the periods of inactivity, the forces to which the molds are subjected are clearly very high.

Furthermore, as described above, each mold is made from a plurality of parts, typically two parts, hinged to each other in such a way that they can be opened when the heated preform is inserted. Once the mold has been inserted into the space that it is to occupy, the two parts of the mold are closed and, since the upper cover fits the top of the mold precisely, air under pressure can be injected into the closed mold, so as to stretch the heated and softened preform and press it against the inner walls of the two parts of the closed mold. It has also been specified that use can be made of an elongation rod which penetrates along the axis of symmetry of the preform so as to stretch it inside the mold.

Thus the mold receives hot air at very high pressure and is consequently subjected to an additional force which has to be compensated so as to prevent the deformation of the mold during blowing and/or stretching. Failing this, the final shape of the blow-molded container is incorrect, and the container has to be rejected from the production batch, incurring costs of detection and rejection, while the mold can also undergo deformations which may even lead to its destruction.

A device called a “mold-carrier unit”, inside which the two parts of the mold are fixed, is disclosed in the prior art. The mold-carrier unit makes it possible to isolate the mold parts from the exterior during the molding operation, and also to synchronize the closing of the mold parts with the rotary movement of the rotating plate which carries the set of molds associated with the blow-molding machine.

Consequently, the mold-carrier unit also makes an essential contribution to the rigidity of the assembly of mold parts, while making the handling of the preform and of the mold parts as precise and rapid as possible.

For this purpose, the prior art teaches the forming of a mold-carrier unit essentially having a base and at least two mold-carrier parts which are adapted
to enclose the mold base with their lower parts, and
to support and hold the mold parts.

In the prior art, there is a known method of making rotating plates which carry up to forty-eight or even more identical mold-carrier units. Since the rotation speeds are extremely high, and the pressures inside the mold during blowing are also extremely high, at more than 40 bars, the mold-carrier units must include sufficient rigid material to provide a degree of rigidity which ensures the correct molding of the finished container.

Up to the present time, this result has mainly been achieved by using an additional quantity of material, generally a special steel which withstands heat, pressure and the centrifugal force created by the rotation of the rotating plate, whenever the production rate has to be increased.

Consequently, a mold-carrier unit currently represents a considerable moving mass, and the manufacture and transport of such a machine, as well as its maintenance and use at high rates, are made more difficult if it is desired to achieve a degree of rigidity which has a positive effect on molding quality.

The invention provides an improvement to the prior art mold-carrier units, in that it permits a considerable reduction in the mass of material required to provide sufficient rigidity for a given molding quality. The present invention relates to a mold-carrier unit characterized in that it has at least one rotatably movable panel carrying hinge lugs on a first edge and carrying locking lugs on a second edge. The movable panel has at least one rib enabling at least one locking lug to be connected to at least one hinge lug in such a way that the rib reinforces the rigidity of the mold-carrier unit.

According to one aspect of the invention, the width of a rib connected to a locking lug increases with the distance from the locking lug.

According to one aspect of the invention, the width of a rib connected to a hinge lug increases with the distance from the hinge lug.

According to one aspect of the invention, on a movable panel, a rib extending from a hinge lug or from a locking lug is connected by a link of material to at least one rib extending from a locking lug or extending from at least one hinge lug respectively.

According to one aspect of the invention, the ribs are oriented obliquely relative to the central axis of the mold-carrier unit.

According to one aspect of the invention, a fastening lug is connected by a plurality of ribs to a plurality of hinge lugs.

According to one aspect of the invention, at least one locking lug on a locking edge of a movable panel consists of a pair of locking lugs, in such a way that a space is created between the two lugs for the interposition of a locking lug of a locking edge of another panel of the unit.

According to one aspect of the invention, one of the locking edges has a single rod and a plurality of pins, each connected by a linking rod to said rod, the pins being designed to penetrate the facing holes of the fastening lugs after the mold-carrier unit has been closed.

The invention will be made clearer by the following description and the drawings, in which:

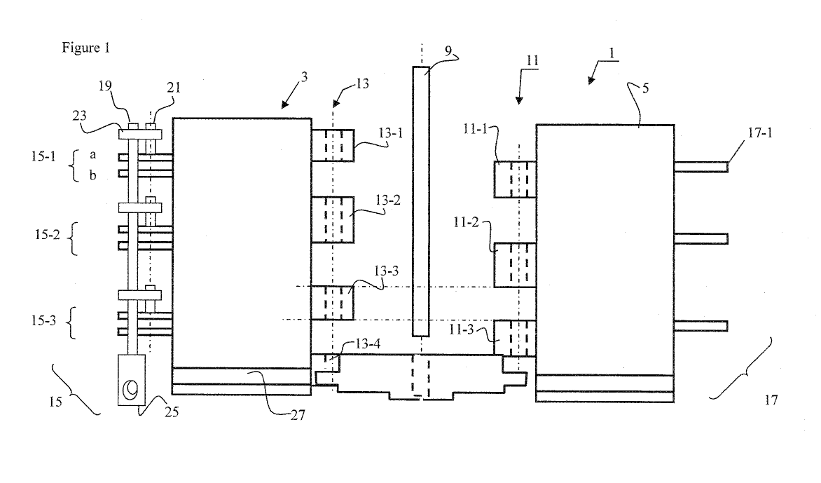

FIG. 1 shows a general view of four essential components of a specific embodiment of a mold-carrier unit according to the invention;

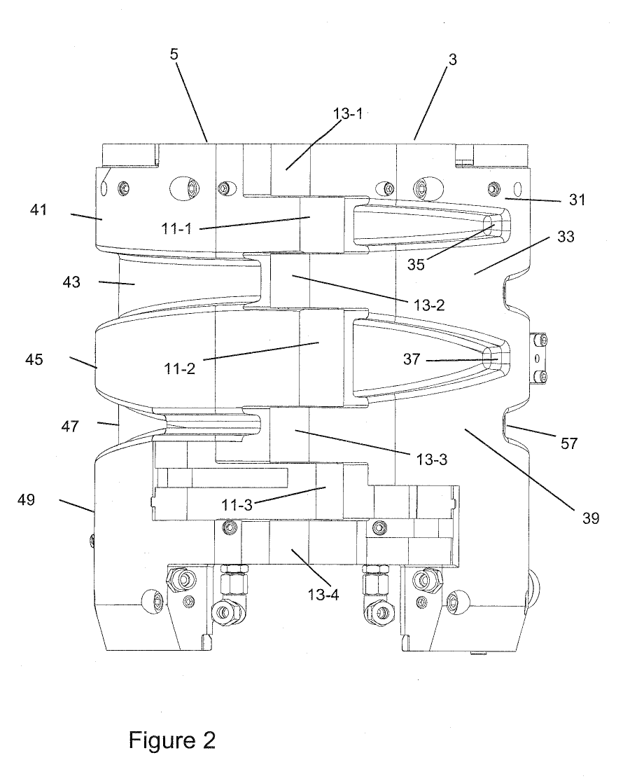

FIG. 2 shows part of a mold-carrier unit in a specific embodiment of the invention, viewed from the side of its opening hinge system;

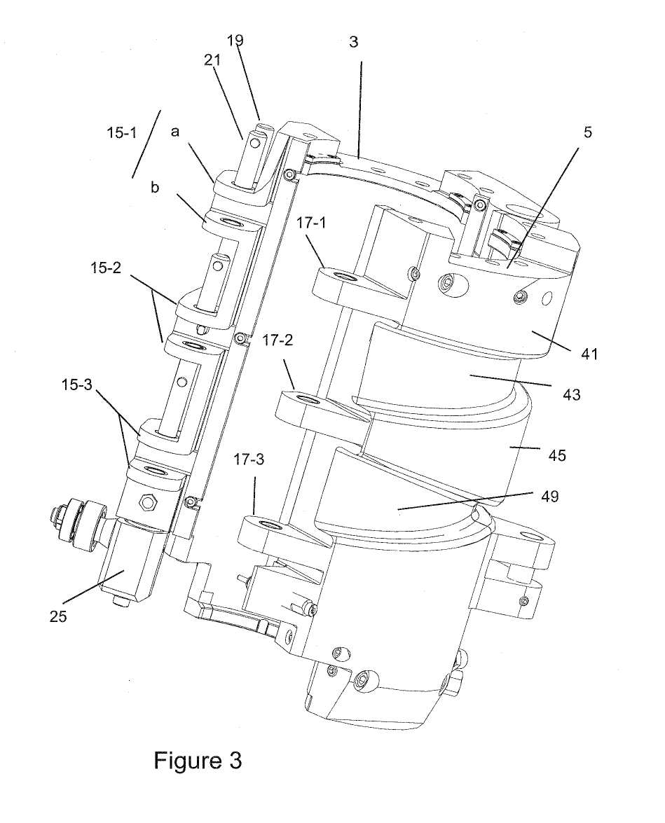

FIG. 3 shows a perspective view of the mold-carrier unit of FIG. 2, viewed from the locking side and showing a first panel of the mold-carrier unit; and

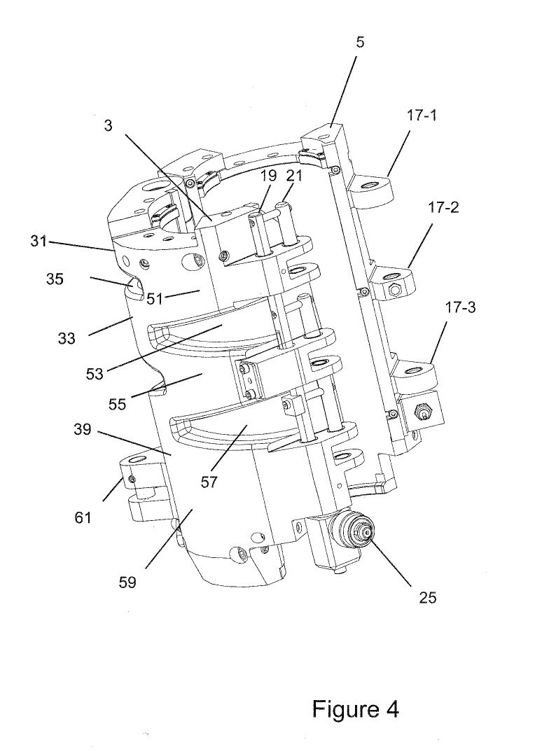

FIG. 4 shows a perspective view of the mold-carrier unit of FIG. 2, viewed from the locking side and showing a second panel of the mold-carrier unit.

FIG. 1 shows a general view of four essential components of a specific embodiment of a mold-carrier unit according to the invention. The mold-carrier unit 1 of FIG. 1 has two panels 3 and 5, consisting of semicylindrical plates, having two parallel vertical edges, a lower semicircular edge designed to bear on the edge of a mold base 7, and an upper semicircular edge designed to form the opening of the mold-carrier unit through which the preform and its blowing device which supports it are to be inserted when the mold-carrier unit is open.

In order to avoid excessive complexity in the following drawings, the two mold parts, each of which is mounted on the semicylindrical face, shown in FIG. 1, of each of the panels 3 and 5 of the mold-carrier unit 1, are not shown. Similarly, the mold base 7 is not provided with the mold base part itself, which is positioned on the upper part of the mold base 7.

Thus each mold panel has an edge carrying hinge lugs, each lug having a hole designed to receive a common hinge pin 9, a vacant space being provided between two hinge lugs on the same edge of the panel of the mold-carrier unit, so as to receive the complementary lug of the other edge of the other panel of the mold-carrier unit.

The first edge 13 of the left-hand panel 3 carries four hinge lugs, numbered 13-1, 13-2, 13-3 and 13-4 respectively. The first edge 11 of the right-hand panel 5 carries three hinge lugs, numbered 11-1, 11-2 and 11-3 respectively. When the assembly of the edge is completed, the hinge pin 9 is inserted through the holes (not identified by reference numerals) of the different lugs, thus forming the hinge of the mold-carrier unit. Clearly, therefore, the two panels are movable with respect to each other about the common hinge pin 9 during the operation of the mold-carrier unit, thus enabling the mold-carrier unit to be opened when the molded container is ejected and when the heated preform is inserted before the blowing operation.

The mold base 7 has a peripheral edge 29 designed to engage in grooves 27 of the lower parts of the left-hand panel 3 and of the right-hand panel 5 when the mold-carrier unit is closed. When the mold-carrier unit is open, the mold base 7 is lowered, thus ensuring the detachment of the formed container and assisting in its transfer towards the formed container finishing process.

Each panel of the mold-carrier unit also has a second edge designed to carry locking lugs. On the second edge 15, called the locking edge, of the left-hand panel 3, a set of rods is shown, composed of a single rod 19 and a plurality of locking pins 21, each associated by means of a linking rod such as the rod 23 with the single rod 19 and moved by means of a pulling piece 25 fixed to the bottom of the rod 19. The rod 19 passes through a plurality of pairs 15-1, 15-2 and 15-3 of locking lugs. Each pair of locking lugs, such as the pair 15-1, has two locking lugs proper, identified as a and b, the space between which is calculated to receive a corresponding locking lug 17-1 of the second edge 17 or locking edge of the right-hand movable panel 5.

When the mold-carrier unit is to be closed, a downward movement is imparted to the pulling piece 25, which carries a cam follower (not shown), thus causing each locking pin 21 fixed to the main rod 19 by the horizontal rod 23 to move downward, thereby passing through the holes in the lugs a and b of the pair of lugs 15-1 and in the lug which is engaged between them, namely the lug 17-1 of the locking edge of the right-hand panel 5.

For unlocking, the pulling piece 25, driven by a cam which is not shown and which is positioned in relation to the rotary movement of the rotating plate (not shown) on which the mold-carrier unit is mounted, is made to move upward, in such a way that the locking pins 21 rise again and enable the two rotatably movable panels 3 and 5 to be opened by means of an opening mechanism of the mold-carrier unit, which is not shown in FIG. 1. Persons skilled in the art will be able to consult documents published in the name of the present applicant, which describe the opening mechanisms of mold-carrier units.

In the prior art, the arrangement of the locking lugs on one side and the hinge lugs on the other side is considered to impart sufficient rigidity, provided that the panels of the mold-carrier unit are sufficiently thick. As described above, this causes an increase in the inertia of each mold-carrier unit and of the rotating plate fitted with the units.

According to the invention, as shown in FIGS. 2 to 4, the outer face (not shown in FIG. 1) of each rotatably movable panel of the mold-carrier unit is reduced in thickness, thereby limiting the necessary quantity of material, but is provided with a plurality of stiffening grooves or ribs positioned as described below.

In FIG. 2, a mold-carrier unit according to a specific embodiment of the invention is shown from the rear of the side carrying the hinge for opening the movable panels 3 and 5.

According to an essential feature of the invention, each hinge lug of each movable panel is associated with a rib.

On the panel 5 of FIG. 2, three hinge lugs are distributed in the following manner. A central lug 11-2 having a first width is surrounded by two lateral lugs, namely an upper lug 11-1 and a lower lug 11-3, having a second width, the first width being greater than said second width. The central lug 11-2 is connected to a rib 45 whose width decreases. The two outer lugs 11-1 and 11-3 are connected to their ribs 41 and 49. The three successive ribs 41, 45 and 49 are therefore separated by two grooves 43 and 47.

On the panel 3 of FIG. 2, four hinge lugs are distributed in the following manner. The hinge lugs 13-1 to 13-4 are interleaved with the three hinge lugs of panel 5. The widths of the four hinge lugs 14-1 to 14-4 are substantially identical, and each of these hinge lugs is connected to the rib 31, 33 or 39. The width of the top rib 31 increases, and the subsequent ribs 41 to 49 are therefore separated by two grooves 43 and 47.

FIG. 3 shows the mold-carrier unit of FIG. 2, viewed in perspective from the side of the panel 5. The three fastening lugs of the fastening edge of the panel 5 are of identical width and the profiles of the grooves 43 and 47 which separate the central rib 45 from the upper rib 41 and the lower rib 49 increase as they approach the fastening lugs.

FIG. 3 also shows the elements used for locking the mold-carrier unit when it is closed before the start of the blowing operation. They carry the same reference numerals as the equivalent elements in FIG. 1, and will not be described further. However, the use of these locking elements 19, 21, 25 is combined with the arrangement of the ribs and grooves to achieve the objective of improving the rigidity of the assembly.

FIG. 4 shows the mold-carrier unit of FIG. 2, viewed in perspective from the side of the panel 3, which appeared on the right of FIG. 2. The three pairs of fastening lugs such as the pair 15-1 with its lugs a and b is connected to a single rib 51, while the pair of lugs 15-2 is connected to a rib 55. The widths of the ribs 51, 55 and 59 increase with the distance from their attachment to the pairs of locking lugs, and, conversely, the widths of the grooves 53 and 57 which separate them decrease, as shown in the drawing.

A comparison of FIGS. 3 and 4 shows that, according to one feature of the invention, the ribs connecting the locking lugs to the hinge lugs on the movable panel 3 are positioned so as to form a zigzag. Consequently, the forces are transmitted from the central locking pair 15-2 toward the two upper hinge lugs 13-2 and 13-1 by the pair of ribs 33 and 31 joined to the rib 55, and toward the two lower hinge lugs 13-3 and 13-4 by the rib 39 (see FIGS. 2 and 4).

Additionally, the upper pair of locking lugs 15-1 in FIG. 4 are connected by the rib 51 to the pair of ribs 31 and 33, in such a way that the forces on this pair of locking lugs 15-1 are transmitted to the upper pair of hinge lugs 13-1 and 13-2 by the two grooves 31 and 33 which are connected to the rib 51 by a link of material 35.

Additionally, the lower pair of locking lugs 15-3 in FIG. 4 are connected by the rib 59 to the rib 39 in such a way that the forces on this pair of locking lugs 15-3 are transmitted to the lower pair of hinge lugs 13-3 and 13-4 by the groove 39 which is connected to the rib 59 and to the rib 55.

In particular, the interleaving of the two lugs a and b of each pair of locking lugs on one of the edges with a single locking lug on the other edge ensures a balanced distribution of forces on each central locking panel when the mold-carrier unit is closed. This arrangement contributes to the rigidity of the assembly when the forces transferred by the ribs toward a plurality of hinge lugs are made to intersect. Additionally, the transfer of forces is oriented in oblique directions relative to the central axis of the mold-carrier unit by the arrangement of the oblique and/or zigzag ribs which are described above.

1-8. (canceled)

9. A mold-carrier unit for a machine for manufacturing containers by blow-molding or stretch-blowing, and by elongation if necessary, from a preform of thermoplastic material, characterized in that it has at least one rotatably movable panel (3, 5) carrying hinge lugs on a first edge and carrying locking lugs (17; 15) on a second edge, the movable panel having at least one rib (31, 33, 39; 41, 45, 49) enabling at least one locking lug to be coupled to at least one hinge lug in such a way that the rib reinforces the rigidity of the mold-carrier unit.

10. The mold-carrier unit as claimed in claim 9, characterized in that the width of a rib (45) connected to a locking lug (17-2) increases with the distance from the locking lug.

11. The mold-carrier unit as claimed in claim 9, characterized in that the width of a rib (33) connected to a hinge lug (13-2) increases with the distance from the hinge lug.

12. The mold-carrier unit as claimed in claim 11, characterized in that, on a movable panel (3), a rib extending (33) from a hinge lug (13-2) or extending (55) from a locking lug (15-2) is connected by a link of material (35, 37) to at least one rib extending (51, 55) from a locking lug (15-1, 15-2) or extending (33, 39) from at least one hinge lug (13-2, 13-3) respectively.

13. The mold-carrier unit as claimed in claim 9, characterized in that the ribs are oriented obliquely relative to the central axis of the mold-carrier unit.

14. The mold-carrier unit as claimed in claim 9, characterized in that one fastening lug is connected by a plurality of ribs to a plurality of hinge lugs.

15. The mold-carrier unit as claimed in claim 9, characterized in that at least one locking lug on a locking edge of a movable panel consists of a pair of locking lugs, in such a way that a space is created between the two lugs (a, b) for the interposition of a locking lug of a locking edge of another panel of the unit.

16. The mold-carrier unit as claimed in claim 15, characterized in that one of the locking edges has a single rod (19) and a plurality of pins (21), each connected by a linking rod (23) to said rod (19), the pins being designed to penetrate the facing holes of the fastening lugs after the mold-carrier unit has been closed.

17. The mold-carrier unit as claimed in claim 10, characterized in that the width of a rib (33) connected to a hinge lug (13-2) increases with the distance from the hinge lug.

18. The mold-carrier unit as claimed in claim 10, characterized in that the ribs are oriented obliquely relative to the central axis of the mold-carrier unit.

19. The mold-carrier unit as claimed in claim 10, characterized in that one fastening lug is connected by a plurality of ribs to a plurality of hinge lugs.

20. The mold-carrier unit as claimed in claim 10, characterized in that at least one locking lug on a locking edge of a movable panel consists of a pair of locking lugs, in such a way that a space is created between the two lugs (a, b) for the interposition of a locking lug of a locking edge of another panel of the unit.

21. The mold-carrier unit as claimed in claim 11, characterized in that the ribs are oriented obliquely relative to the central axis of the mold-carrier unit.

22. The mold-carrier unit as claimed in claim 11, characterized in that one fastening lug is connected by a plurality of ribs to a plurality of hinge lugs.

23. The mold-carrier unit as claimed in claim 11, characterized in that at least one locking lug on a locking edge of a movable panel consists of a pair of locking lugs, in such a way that a space is created between the two lugs (a, b) for the interposition of a locking lug of a locking edge of another panel of the unit.
